(19) United States
(12) Patent Application Publication
(10) Pub. No.: US 2013/0226652 A1
(43) Pub. Date: Aug. 29, 2013

(54) RISK ASSESSMENT AND MANAGEMENT

(71) Applicants: Ubaldo G. Bilello, Frankfurt (DE); Hans-Juergen Eickelmann, Nieder-Hilbersheim (DE); Ricardo L. Fabrize, Mooresville, NC (US); Louis R. Ferretti, JR., (US); Udo Kleemann, Stadecken-Elsheim (DE); Jeffrey W. Miles, Cary, NC (US); Michael S. O'Leary, Cary, NC (US); Sharmila S. Tilwalli, Albany, NY (US); Karen N. Toger, Wake Forest, NC (US)

(72) Inventors: Ubaldo G. Bilello, Frankfurt (DE); Hans-Juergen Eickelmann, Nieder-Hilbersheim (DE); Ricardo L. Fabrize, Mooresville, NC (US); Louis R. Ferretti, JR., (US); Udo Kleemann, Stadecken-Elsheim (DE); Jeffrey W. Miles, Cary, NC (US); Michael S. O'Leary, Cary, NC (US); Sharmila S. Tilwalli, Albany, NY (US); Karen N. Toger, Wake Forest, NC (US)

(73) Assignee: INTERNATIONAL BUSINESS MACHINES CORPORATION, Armonk, NY (US)

(21) Appl. No.: 13/407,627

(22) Filed: Feb. 28, 2012

(51) Int. Cl. G06Q 10/06

(52) U.S. Cl. 705/7.28

(57) ABSTRACT

Embodiments of the invention relate to identification of risks in a brand commodity supply chain. Risks are centrally assessed and a single holistic image of the risk assessment is provided. Specifically, risks are assessed vertically and horizontally across the supply chain, brand, and commodity. Risk identification techniques may be applied to the identified risks to reduce supply chain disruption and to enable continued manufacturing.

### BACKGROUND

This invention relates to risk assessment and management of aspects of a supply chain. More specifically, the invention relates to identification and management of risks in the supply chain, and deployment of risk mitigation.

Domestic and global operating companies are dependent on sustained and on-time delivery of their supply chains. Both sustainability and on-time delivery can be threatened by multiple risk factors outside of the control of such companies. However, knowing these risk factors in advance enables companies to work on risk mitigation plans ahead of any disruptions. Although there are tools available pertaining to supply chains and product delivery, there are performance issues with risk identification and evaluation of the impact of risk situations.

### BRIEF SUMMARY

This invention comprises a method, system, and article for risk assessment and management thereof.

In one aspect, a computer implemented method is provided for risk assessment. Risks in a brand commodity supply-chain for delivering a commodity into a brand are identified. The risk identification includes risks for both an intermediate component supply-chain and a final assembly supply-chain. A visible relationship is formed among disparate pieces of information associated with the identified risks. More specifically, the visible relationship includes logically organizing the disparate pieces of information and creating a single holistic image for visualizing risks in the brand commodity supply chain. A relevant supply chain for a risk assessment is identified. In addition, the identified risks for impact evaluation are evaluated. This identification and evaluation includes integrating the identified risks for both the intermediate component supply-chain and the final assembly supply-chain with an aggregation of elements in the supply chains. Finally, key risks in response to the impact evaluation are managed. This management includes deployment of risk mitigation of a risk identified as affecting supply chain sustainability.

In another aspect, a system is provided with tools to support risk assessment and management. A processor is provided in communication with memory. In addition, a functional unit is provided in communication with the memory. The functional unit includes tools to support risk assessment. The tools include, but are not limited to, a risk identification manager, a relationship manager, a supply chain manager, and a director. The risk identification manager functions to identify risks in a brand commodity supply-chain employed to deliver a commodity into a brand. The identified risks include a first risk for an immediate component supply-chain and a second risk for a final assembly supply-chain. The relationship manager is provided in communication with the risk identification manager. More specifically, the relationship manager forms a visible relationship among disparate pieces of information associated with the identified risks. The relationship manager functions to logically organize the disparate pieces of information and to create a single holistic image for risks in the brand commodity supply chain. The supply chain manager is provided in communication with the relationship manager. More specifically, the supply chain manager functions to identify a relevant supply chain for a risk assessment and to evaluate the identified risks for impact evaluation. The supply chain manager integrates the identified risks for both the intermediate component supply-chain and the final assembly supply-chair, with an aggregation of elements in the supply chain. Finally, the director, which is provided in communication with the supply chain manager, functions to manage key risks in response to the impact evaluation. The director deploys risk mitigation of a risk identified as affecting supply chain sustainability.

In a further aspect, a computer program product is provided for risk assessment and management. The computer program product comprises a computer readable storage medium having computer readable program code embodied therewith. Computer readable program code is configured to identify risks in a brand commodity supply chain for delivering a commodity into a brand. The risk identification includes risks for both an intermediate component supply-chain and a final assembly supply-chain. Program code is provided to form a visible relationship among disparate pieces of information associated with the identified risks. More specifically, the program code logically organizes the disparate pieces of information and creates a single holistic image to visualize risks in the brand commodity supply chain. Program code is also provided to identify a relevant supply chain for a risk assessment and to evaluate the identified risks for impact evaluation. The identification and evaluation code includes integrating the identified risks for both the intermediate component supply-chain and the final assembly supply-chain with an aggregation of elements in the supply chains. Finally, program code is provided to manage key risks in response to the impact evaluation, including deployment of risk mitigation for a risk identified as affecting supply chain sustainability.

Other features and advantages of this invention will become apparent from the following detailed description of the presently preferred embodiment of the invention, taken in conjunction with the accompanying drawings.

### BRIEF DESCRIPTION OF THE SEVERAL VIEWS OF THE DRAWINGS

The drawings referenced herein form a part of the specification. Features shown in the drawings are meant as illustrative of only some embodiments of the invention, and not of all embodiments of the invention unless otherwise explicitly indicated.

FIG. 1 is a flow chart illustrating a global view of a task-flow to provide risk assessment.

FIG. 2 depicts is a flow chart illustrating assigning a measurement to each risk category.

FIG. 3 depicts a flow chart illustrating assessing an impact value for each of the risk categories of an aspect of the supply chain, and more specifically, illustrating assignment of an impact value to the measurement.

FIG. 4 depicts a flow chart illustrating selection of impact values for a likelihood value and an impact value.

FIG. 5 depicts a flow chart illustrating a process for aggregating the likelihood and impact values for each risk category with an aggregated likelihood and impact values for an aspect of the supply chain.

FIG. 6 is a flow chart illustrating a process for aggregating the likelihood-impact values for each aspect of a supply chain into an aggregated likelihood-impact value for the supply chain.

FIG. 7 depicts a block diagram illustrating the supply chains and how they supply a specific commodity for different brands.

FIG. 8 depicts a flow chart illustrating a process for aggregating a totality of supply chains supplying a selected or common commodity.

FIG. 9 depicts a block diagram illustrating the supply chains and how they supply different commodities for a specific brand.

FIG. 10 depicts a flow chart illustrating a process for aggregating a totality of supply chains supplying a selected brand or organizational entity.

FIG. 11 depicts a block diagram illustrating tools embedded in a computer system to support the identification, aggregation, and assessment in one or more supply chains.

FIG. 12 depicts a block diagram showing a system for implementing an embodiment of the present invention.

### DETAILED DESCRIPTION

It will be readily understood that the components of the present invention, as generally described and illustrated in the Figures herein, may be arranged and designed in a wide variety of different configurations. Thus, the following detailed description of the embodiments of the apparatus, system, and method of the present invention, as presented in the Figures, is not intended to limit the scope of the invention, as claimed, but is merely representative of selected embodiments of the invention.

The functional unit(s) described in this specification has been labeled with tools in the form of managers and a director. A manager and/or director may be implemented in programmable hardware devices such as field programmable gate arrays, programmable array logic, programmable logic devices, or the like. The managers and/or director may also be implemented in software for processing by various types of processors. An identified manager of executable code may, for instance, comprise one or more physical or logical blocks of computer instructions which may, for instance, be organized as an object, procedure, function, or other construct. Nevertheless, the executables of an identified manager need not be physically located together, but may comprise disparate instructions stored in different locations which, when joined logically together, comprise the managers and/or director and achieve the stated purpose of the managers and/or director.

Indeed, a manager or director of executable code could be a single instruction, or many instructions, and may even be distributed over several different code segments, among different applications, and across several memory devices. Similarly, operational data may be identified and illustrated herein within the manager or director, and may be embodied in any suitable form and organized within any suitable type of data structure. The operational data may be collected as a single data set, or may be distributed over different locations including over different storage devices, and may exist, at least partially, as electronic signals on a system or network.

Reference throughout this specification to “a select embodiment,” “one embodiment,” or “an embodiment” means that a particular feature, structure, or characteristic described in connection with the embodiment is included in at least one embodiment of the present invention. Thus, appearances of the phrases “a select embodiment,” “in one embodiment,” or “in an embodiment” in various places throughout this specification are not necessarily referring to the same embodiment.

Furthermore, the described features, structures, or characteristics may be combined in any suitable manner in one or more embodiments. In the following description, numerous specific details are provided, such as examples of a risk identification manager, a relationship manager, a supply chain manager, a risk category manager, an impact manager, and a director, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

The illustrated embodiments of the invention will be best understood by reference to the drawings, wherein like parts are designated by like numerals throughout. The following description is intended only by way of example, and simply illustrates certain selected embodiments of devices, systems, and processes that are consistent with the invention as claimed herein.

The total risk assessment method and system described herein focuses on the risk identification and impact evaluation processes, each addressing an appropriate conceptual risk category. Risk mitigation is deployed on migration oriented tools and processes. Risk assessment described herein evaluates, identifies, and manages key risks within a global supply chain. More specifically, risk assessment employs queries and associated responses to capture different aspects of risk in a supply chain. In one embodiment, these queries address risk in countries, hubs, supplier, and supplier sites. The risk assessment method and system uses a likelihood-impact and meantime-to-repair model for calculating risk levels associated with query responses. More specifically, the responses are employed to aggregate the risk per entity and for the entire supply chain. In one embodiment, the queries are employed to assess effectiveness of a supplier's preparation for a pandemic and to determine if mitigation plans are in place to guarantee supply continuity. Accordingly, each entity in the supply chain is individually assessed for each of the identified risk categories and their risk values are rolled up to product level using a likelihood-impact model.

The risk aggregation model is based on the concept of brand-commodity-supply chain (BSC). A BSC is a supply chain which delivers a commodity into a brand for a final assembly. In one embodiment, the BSC is composed of aspects of a supply chain, including but not limited to, country, supplier site, supplier, hub-in, hub-out, and commodity. Each BSC entity is assessed with queries from which probability and impact relating to a potential risk situation is identified. A risk category of the supply chain aspect is related to a question in an associated risk assessment. For example, the risk assessment may be associated with crime. The supply chain includes an intermediate supply chain and a final assembly supply chain. The intermediate supply chain is a supply chain supplying a commodity which is not delivered to a brand for final assembly. Conversely, the final assembly supply chain is a supply chain supplying a commodity which is delivered to a brand for final assembly. Accordingly, both intermediate and final aspects of supply chain and associated delivery are considered for the risk aggregation model.

Different aspects of risk assessments are calculated, including, but not limited to, mean time to repair, assessment of likelihood of risk, assessment of meantime to repair, and assessment of impact. The mean time to repair is an average time of a non-operation status of a supply chain risk category. For example, if it is determined that the non-operation status is for five days, the mean time to repair is 5/365, and translated to 1.4%. The assessment of likelihood of risk includes assignment of a verbally defined risk value to a risk category, e.g. unlikely, very unlikely, etc. The assessment of meantime to repair includes assigning a time to a risk category. In one embodiment, the time may include days per year. The assessment of impact includes assigning a defined impact value to a risk category. In one embodiment, the defined impact may be verbal. Each of the above described assessments may be employed to calculate a likelihood value. More specifically, the assessment of likelihood of risk, meantime to repair, etc. may be transformed into numerical values based upon a set of predefined rule for each risk category.

The likelihood and impact values for individual questions are assigned for each questions, thereby allowing for maximum flexibility. In one embodiment, the following is the base scale for likelihood values on a scale from 0 to 1, e.g. from 0% to 100%:

TABLE 1

| | |
|---|---|
| Not Expected | 0.5% |
| Very Unlikely | 1.5% |
| Unlikely | 4.5% |
| Possible | 15% |
| Expected | 45% |

In one embodiment, the following is the base scale for impact values on a scale from 0 to 1, e.g. from 0% to 100%:

TABLE 2

| | |
|---|---|
| None | 0.5% |
| Very Low | 1.5% |
| Low | 4.5% |
| Medium | 15% |
| High | 45% |

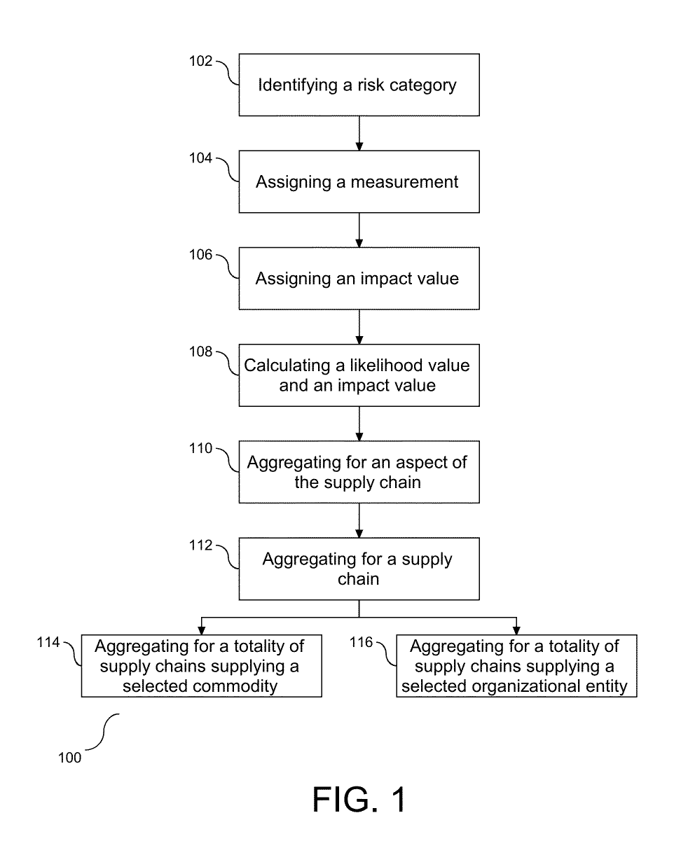

A supply chain risk is assessed in several directions and dimensions, including tactically and operationally, and in view of the passage of time. More specifically, a supply chain risk assessment identifies risks in a brand commodity supply chain for delivering a commodity into a brand. This includes risk identification and assessment for both an intermediate component supply chain and a final assembly supply chain. FIG. 1 is a flow chart (100) illustrating a global view of the task-flow to provide risk assessment. Each of the steps illustrating in this figure will be explain in further detail in the subsequent diagrams and written description. Initially, a risk category is identified (102) and assigned both a measurement (104) and an impact value (106). In one embodiment, a risk category is assigned a measurement through one or more questions, of which the answers to the questions may be aggregated to provide a likelihood of impact value or meantime to repair value. Risk categories may come in different forms, such as natural disasters, political fallout, etc. Based upon the assigned measurement and value at steps (104) and (106), both a likelihood of impact value and meantime to repair value are calculated (108). Thereafter, an aggregation is performed for an aspect of the supply chain (110) as well as for the supply chain (112). More specifically, the aspect of aggregating a supply chain includes aggregating a totality of supply chains supplying a selected commodity (114) and aggregating a totality of supply chains supplying a selected organizational entity (116). The supply chain risk assessment is employed as a tool to manage risks in response to impact evaluation.

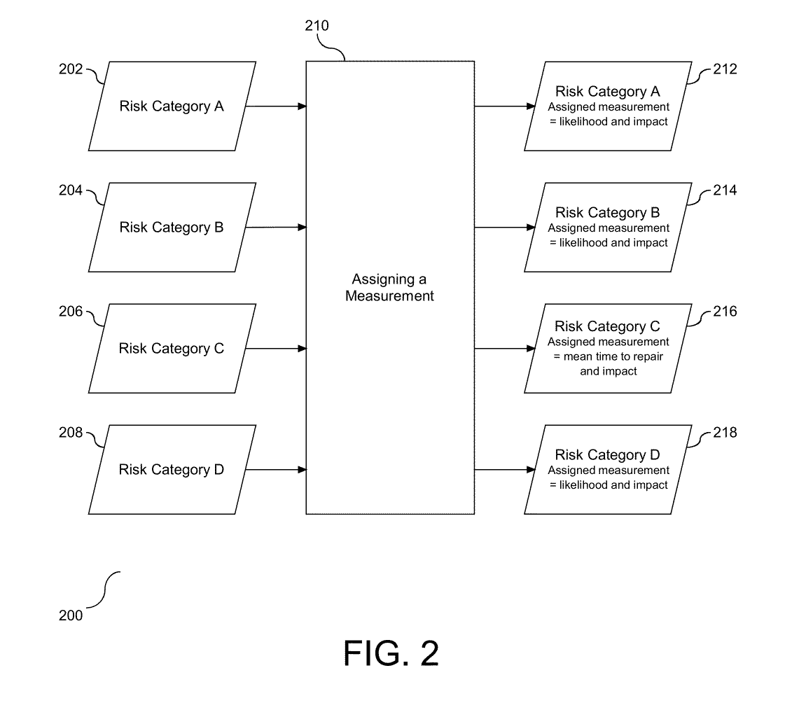

FIG. 2 is a flow diagram (200) illustrating a process for assigning a measurement to each risk category. As shown herein, there are four risk categories (202), (204), (206), and (208). Although four risk categories are shown, the invention should not be limited to this quantity. In one embodiment, there may be a smaller or larger quantity of risk categories provided for measurement assignment. Each of the assigned measurements (210) may be either a meantime to repair and impact measurement or a likelihood-impact measurement. As shown in this example, the first risk category is assigned a likelihood and impact measurement (212). The second risk category is assigned a likelihood and impact measurement (214). The third risk category is assigned a meantime to repair and impact measurement (216). The fourth risk category is assigned a likelihood and impact measurement (218). Accordingly, each identified risk category is assigned a measurement.

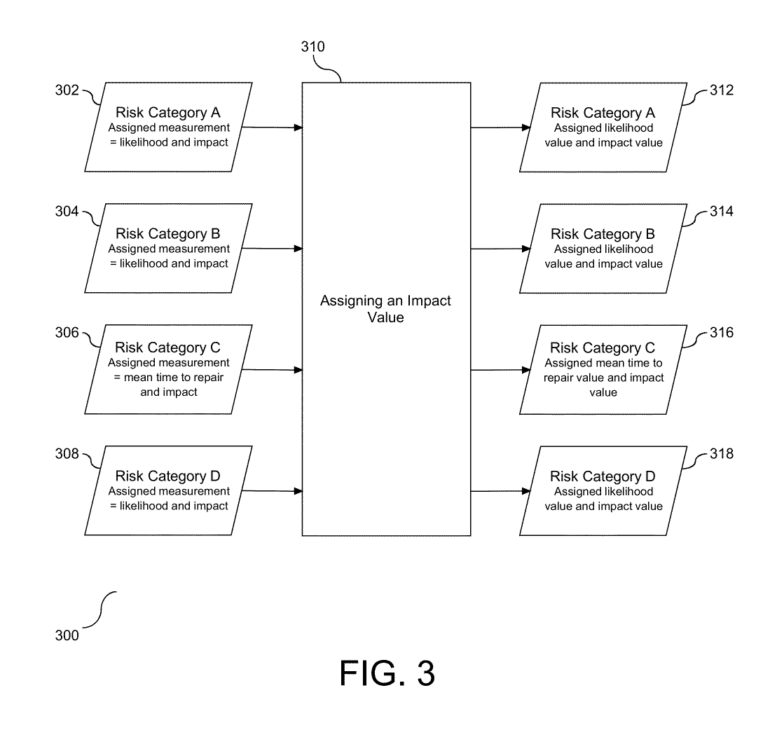

As shown in FIG. 2, each of the risk categories are identified and assigned a measurement. FIG. 3 is a flow diagram (300) illustrating the process of assessing an impact value for each of the risk categories of an aspect of the supply chain, and more specifically, illustrating assignment of an impact value to the measurement. As shown, there are four defined risk categories, each assigned a measurement. More specifically, the first risk category is assigned a likelihood and impact measurement (302), the second risk category is assigned a likelihood and impact measurement (304), the third risk category is assigned a meantime to repair and impact measurement (306), and the fourth risk category is assigned a likelihood and impact measurement (308). Each of the assignment measurements is assigned an impact value (310). More specifically, the assignment of the impact value to the measurement is either a mean time to repair and impact value or a likelihood and impact value. As such, the first risk category is assigned a likelihood and impact value (312). The second risk category is assigned a likelihood and impact value (314). The third risk category is assigned a mean time to repair and impact value (316). The fourth risk category is assigned a mean time to repair and impact value (318). In one embodiment, each of the assessed impact values is a numerical value based on likelihood of impact, i.e., low impact, high impact, etc. Similarly, in one embodiment, the meantime to repair is a numerical value based on time to repair a certain situation, which in a further embodiment may be based on historical information. Time may be measured in hours, days, weeks, etc. Accordingly, each risk category is assigned a measurement and the measurement is assigned an impact value.

The assignment of values as shown in FIG. 3 are descriptive values. A numerical value is assigned to each of the descriptive values. More specifically, both a likelihood value and an impact value are calculated for each risk category. The likelihood value is assigned based on the scale shown in Table 1, and the impact value is assigned based on the table shown in Table 2. The meantime to repair value is assigned based on the quantity of days for the repair. In one embodiment, the meantime to repair value is greater than zero days but less than one year, e.g. 365 days.

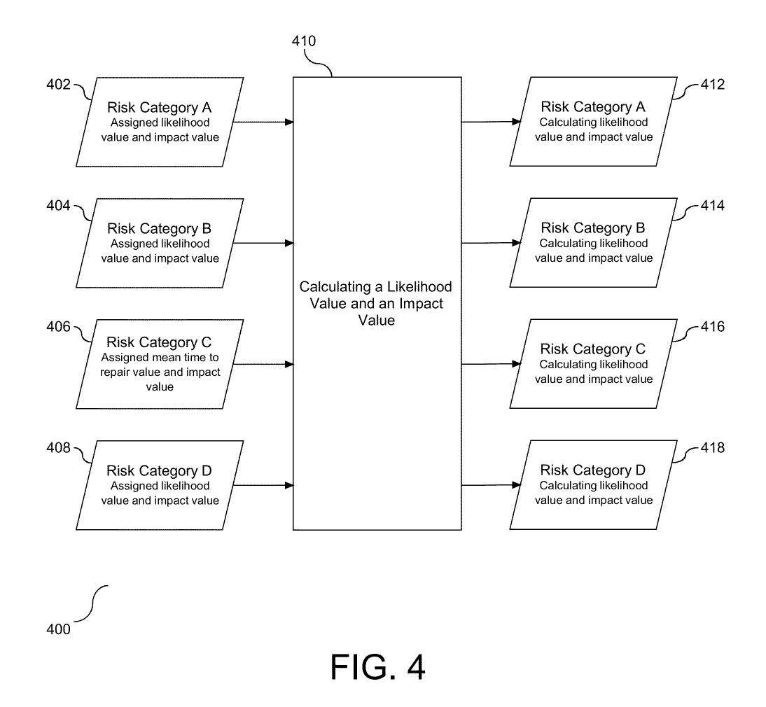

FIG. 4 is a flow diagram (400) illustrating a process for calculating a likelihood value and an impact value. As shown, there are four defined risk categories with each category having an assigned impact value. In the example shown herein, the first risk category has an assigned likelihood value and an impact value (402). The second risk category has an assigned likelihood value and an impact value (404). The third risk category has an assigned meantime to repair and impact value (406). The fourth risk category has an assigned likelihood value and impact value (408). A likelihood and impact value is calculated (410) for each of the risk categories and assigned impact values. More specifically, a likelihood and impact value is calculated for the first risk category (412). The likelihood and impact value is calculated for the second risk category (414). The likelihood and impact value is calculated for the third risk category (416). The likelihood and impact value is calculated for the fourth risk category (418). Risk categories may take different forms, including but not limited to political concerns and unrest, financial concerns, legal, etc. The calculation shown herein pertains to different aspects of a supply chain, including but not limited to, country of supply, hub, supplier, supplier site, and commodity. Accordingly, as shown the likelihood and impact value is individually calculated for each category of an aspect of the supply chain.

The likelihood value and the impact values are separate numerical values. The likelihood values are defined in Table 1, and the impact values are defined in Table 2. The meantime to repair value is calculated based on the following formula:

x days=y %

y=x/365*100

Accordingly, each of the assessed values is assigned a numerical value.

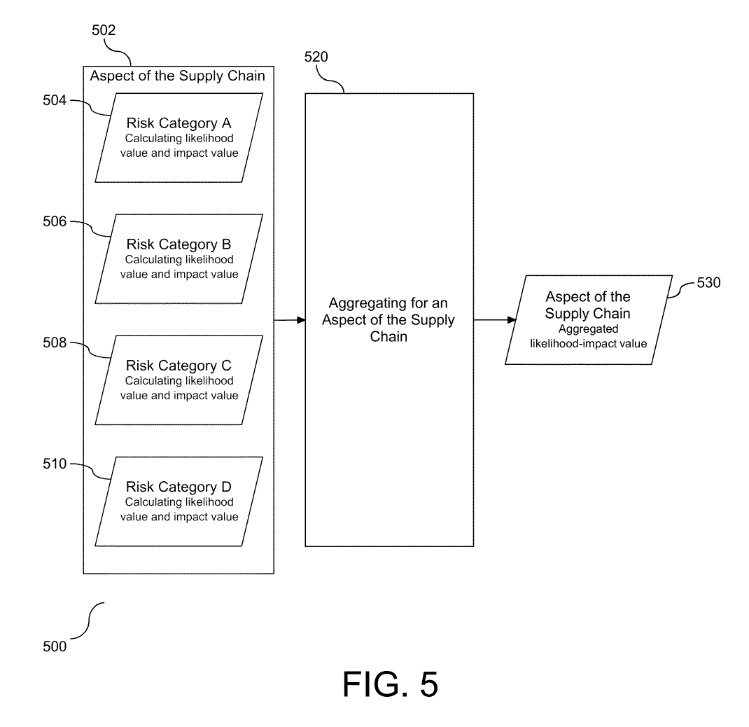

Once the numerical values have been assessed for each risk category, likelihood and impacts values for each risk category of aspects of the supply chain may be aggregated to an aggregated likelihood of impact value for this aspect. FIG. 5 is a flow chart (500) illustrating a process for aggregating the likelihood and impact values for each risk category to an aggregated likelihood and impact values for an aspect of the supply chain. As shown, there are multiple aspects of the supply chain (502). In the example shown herein, the aspects of the supply chain are based upon the defined risk categories and their respectively assessed likelihood and impact values (504), (506), (508), and (510). Each of the defined risk categories are aggregated for an aspect of the supply chain (520) and create an aggregated likelihood-impact value for an aspect of the supply chain (530). In one embodiment, the following formula is employed for aggregating an aspect of the supply chain:

$$[ L ; I ] = [ 1 - {\prod }_{j = 1 , … , n} ( 1 - {l}_{j} ) ; \frac{{\sum }_{j = 1 , … , n} {l}_{j} * {i}_{j}}{{\sum }_{j = 1 , … , n} {l}_{j}} ]$$

where, [L; I] denotes the aggregated likelihood-impact value of the aspect; j=1, . . . , n denote the risk categories to be aggregated; lⱼ denotes the likelihood value of risk category j; and iⱼ denotes the impact value of risk category j. Accordingly, based upon this calculation, all aspects of a supply chain are individually aggregated into a pair of likelihood and impact risk values.

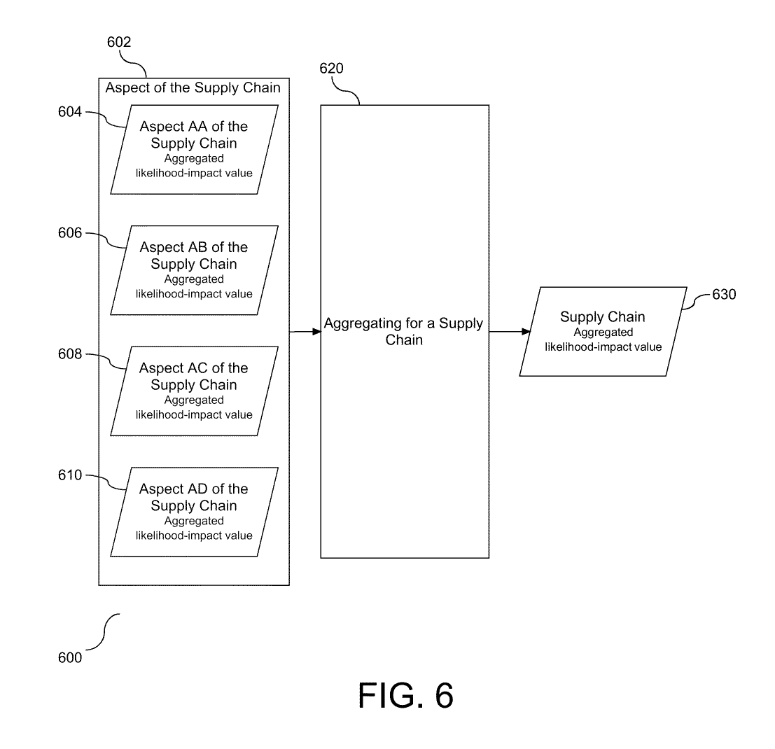

An aggregation may be calculated for each supply chain, and in addition an aggregation may be performed across a totality of supply chains supplying a selected commodity. FIG. 6 is a flow chart (600) illustrating a process for aggregating the likelihood-impact values for each aspect of a supply chain into an aggregated likelihood-impact value for the supply chain. As shown in FIG. 5, different aspects of the supply chain are aggregated. The aggregation of the aspects from FIG. 5 is provided as input (602) into the process of aggregating of a supply chain. More specifically, there are four aspects shown in this example as input (604), (606), (608), and (610). Each of the aggregated likelihood-impact values are aggregated for a supply chain (620) and create an aggregated likelihood-impact value for the supply chain (630). In one embodiment, the following formula is employed for aggregating the supply chain:

$$[ SL ; SI ] = [ 1 - {\prod }_{j = 1 , … , n} ( 1 - {L}_{j} ) ; \frac{{\sum }_{j = 1 , … , n} {L}_{j} * {I}_{j}}{{\sum }_{j = 1 , … , n} {L}_{j}} ]$$

where, [SL; SI] denotes the aggregated likelihood-impact value for the supply chain, j=1, . . . , n denote the aspects to be aggregated, Lⱼ denotes the aggregated likelihood value of the aspect j, and Iⱼ denotes the aggregated impact value of the aspect j. In one embodiment, aspects of the supply chain include, country, hub supplier, supplier site, and commodity. The aggregation of these aspects reports into a brand. For example, the aggregation of Country_{A}, Hub_{A}, Supplier_{A}, Supplier Site_{A}, and Commodity_{A} report into Brand_{A}. Accordingly, based upon this calculation, an aggregation of likelihood impact values for each aspect of the supply chain is assessed for a specific brand.

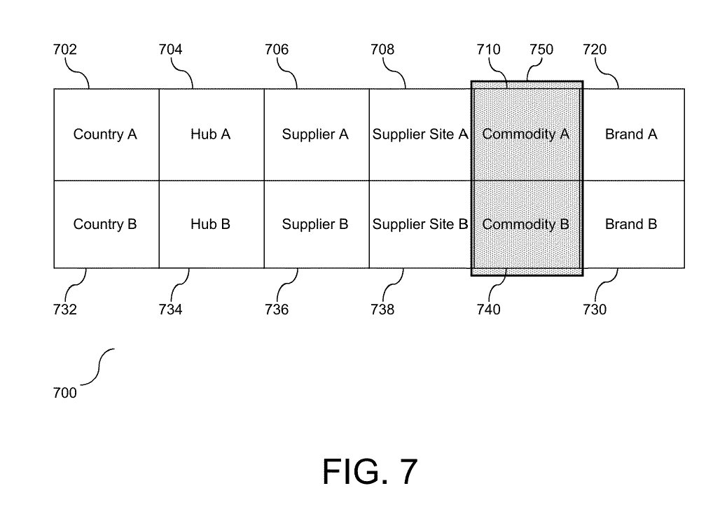

Multiple supply chains may be employed to supply a selected commodity. More specifically, a commodity may be comprised of multiple components with each component emanating from a separate supply chain. FIG. 7 is a block diagram (700) illustrating the supply chains and how they supply a specific commodity although for different brands. As shown, a first Brand_{A} (720) is comprised of the aggregation of Country_{A} (702), Hub_{A} (704), Supplier_{A} (706), Supplier Site_{A} (708), and Commodity_{A} (710). A second Brand_{B} (730) is comprised of the aggregation of Country_{B} (732), Hub_{B} (734), Supplier_{B} (736), Supplier Site_{B} (738), and Commodity_{A} (740). Based on the example, commodity A originates from two different suppliers. Accordingly, the common commodity, Commodity_{A}, may be identified and aggregated (750), e.g. a vertical aggregation of the common commodity.

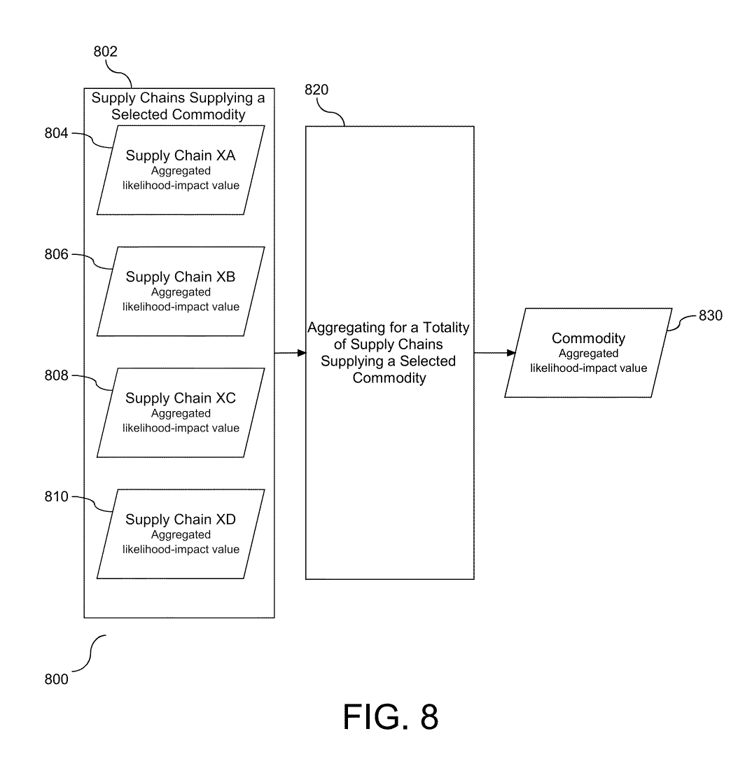

FIG. 8 is a flow chart (800) illustrating a process for aggregating for a totality of supply chains supplying a selected or common brand. As shown, there are multiple supply chains supplying a selected or common brand (802). In the example shown herein, there are four supply chains (804), (806), (808), and (810). However, in one embodiment, there may be a larger or smaller quantity of supply chains supplying a selected or common commodity. The quantity shown here is merely for illustrative purposes. Each of the supply chains (802)-(810) have been aggregated for a likelihood impact value. The multiple supply chains are aggregated for a totality of supply chains supplying a selected or common commodity (820). Each of the aggregated likelihood-impact values are aggregated for a supply chain and create an aggregated likelihood-impact value for the commodity (830). In one embodiment, the following formula is employed for aggregating the multiple supply chains:

$$[ TSL ; TSI ] = [ 1 - {\prod }_{j = 1 , … , n} ( 1 - {SL}_{j} ) ; \frac{{\sum }_{j = 1 , … , n} {SL}_{j} * {SI}_{j}}{{\sum }_{j = 1 , … , n} {SL}_{j}} ]$$

where, [TSL; TSI] denotes the aggregated likelihood-impact value for the totality supply chains, j=1, . . . , n denote the supply chains to be aggregated, SLⱼ denotes the aggregated likelihood value of the supply chain j, and SIⱼ denotes the aggregated impact value of the supply chain j.

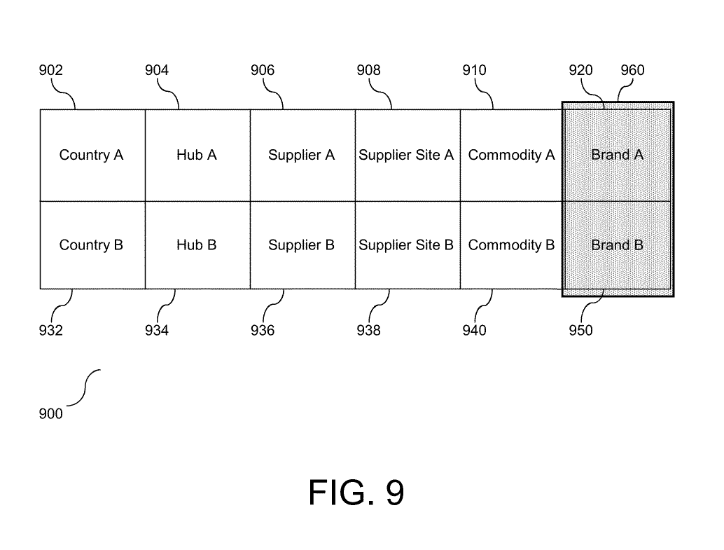

Multiple supply chains may be employed to supply a selected organizational entity. The supply chain may address different commodities or the same commodity. FIG. 9 is a block diagram (900) illustrating the supply chains and how they supply different commodities for a specific brand. In the example shown herein, two supply chains supply a different commodity for the same brand. As shown, a first Brand_{A} (920) is comprised of the aggregation of Country_{A} (902), Hub_{A} (904), Supplier_{A} (906), Supplier Site_{A} (908), and Commodity_{A} (910). The first brand Brand_{A} is also comprised of a second supply chain (950) comprised of the aggregation of Country_{B} (932), Hub_{B} (934), Supplier_{B} (936), Supplier Site_{B} (938), and Commodity_{B} (940). Based on the example, Brand A is comes from two different suppliers. Accordingly, the common brand comprised of two separate commodities, Commodity_{A} and Commodity_{B}, may be identified and aggregated (960), e.g. a vertical aggregation of the common brand.

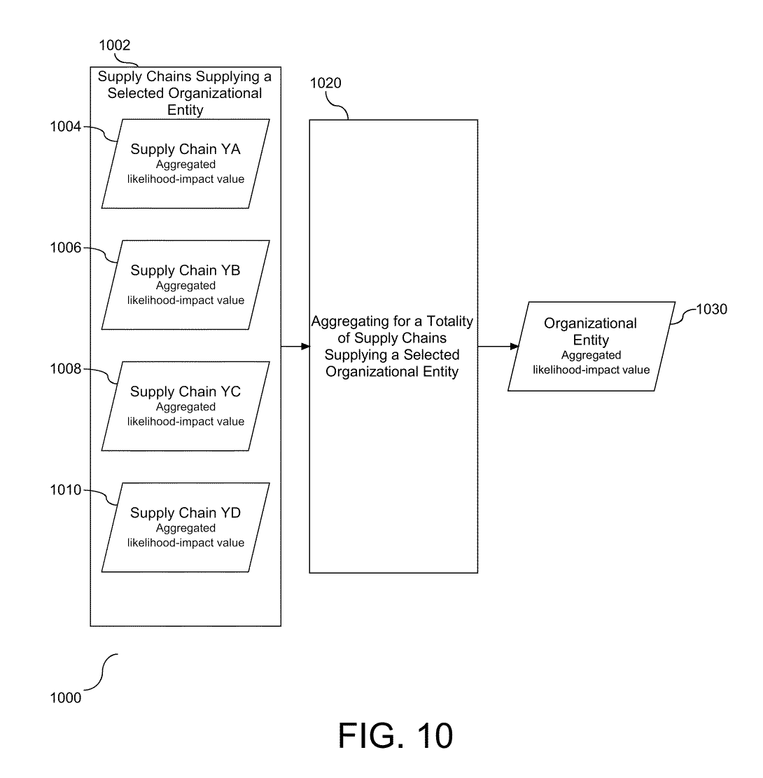

An organizational entity may be comprised of multiple commodities with each commodity emanating from a separate supply chain for a common brand. FIG. 10 is a flow chart (1000) illustrating a process for aggregating for a totality of supply chains supplying a selected brand or organizational entity. As shown, there are multiple supply chains supplying a selected brand or organizational entity (1002). In the example shown herein, there are four supply chains (1004), (1006), (1008), and (1010). However, in one embodiment, there may be a larger or smaller quantity of supply chains supplying a selected organizational entity. The quantity shown here is merely for illustrative purposes. Each of the supply chains (1002)-(1010) have been aggregated for a likelihood impact value. The multiple supply chains are aggregated for a totality of supply chains supplying a selected brand or organizational entity (1020). Each of the aggregated likelihood-impact values are aggregated for a totality of supply chains (1020) and create an aggregated likelihood-impact value for the brand or organizational entity (1030). In one embodiment, the following formula is employed for aggregating the multiple supply chains:

$$[ TSL ; TSI ] = [ 1 - {\prod }_{j = 1 , … , n} ( 1 - {SL}_{j} ) ; \frac{{\sum }_{j = 1 , … , n} {SL}_{j} * {SI}_{j}}{{\sum }_{j = 1 , … , n} {SL}_{j}} ]$$

where, [TSL; TSI] denotes the aggregated likelihood-impact value for the totality supply chains, j=1, . . . , n denote the supply chains to be aggregated, SLⱼ denotes the aggregated likelihood value of the supply chain j, SIⱼ denotes the aggregated impact value of the supply chain j. Accordingly, as shown all likelihood of impact risk values of selected supply chains are aggregated into a single likelihood of impact risk value for a brand.

Disruption of one aspect of a supply chain can disrupt the entire supply chain. The following table is an example of assessments and their effect on probability of disruption in the supply chain:

TABLE 3

| | | Probability of | Probability of no |
|---|---|---|---|
| Country Question | Country Impact | Disruption | Disruption |
| Q1 | Impact1 | P1 | 1-P1 |
| Q2 | Impact2 | P2 | 1-P2 |
| Q3 | Impact3 | P3 | 1-P3 |

Based on the information provided in Table 3, the likelihood of no impact, i.e. no disruption, for the identified country is (1−P1)*(1−P2)*(1−P3), the likelihood of impact, i.e. disruption, for the identified country is 1−[(1−P1)*(1−P2)*(1−P3)], and the impact in case of disruption is (I1*P1+I2*P2+I3*P3)/(P1+P2+P3). Please see the following table for a quantitative example:

TABLE 4

| | | Probability of | Probability of no |
|---|---|---|---|
| Country Question | Country Impact | Disruption | Disruption |
| Q1 | 1 | 5% | 95% |
| Q2 | 4 | 30% | 70% |
| Q3 | 10 | 1% | 99% |

Based on this example and the assessment values provided in Table 1 and Table 2, the likelihood of no disruption is 66%, which is a high probability, the likelihood of disruption is 34%, which is possible, and the impact on distribution is 3.8%, which is unlikely. Risks are assessed for each defined risk category applying to a supply chain, with the assessed risks aggregated with a likelihood and impact value model to provide impact and disruption values.

Each risk is assessed by internal and/or external organizations having knowledge about the associated risks. Changes in an assessed risk level will trigger an alert. The total risk assessment shown herein provides a centralized approach for risk assessment within a company. The risk can be assessed and visualized for the entire supply chain. Risk mitigation plans can be pre-defined ahead of any possible threat to supply sustainability and maintain on-time delivery. Accordingly, the assessment and aggregation provides a robust supply chain to enable continued operation of an organizational entity.

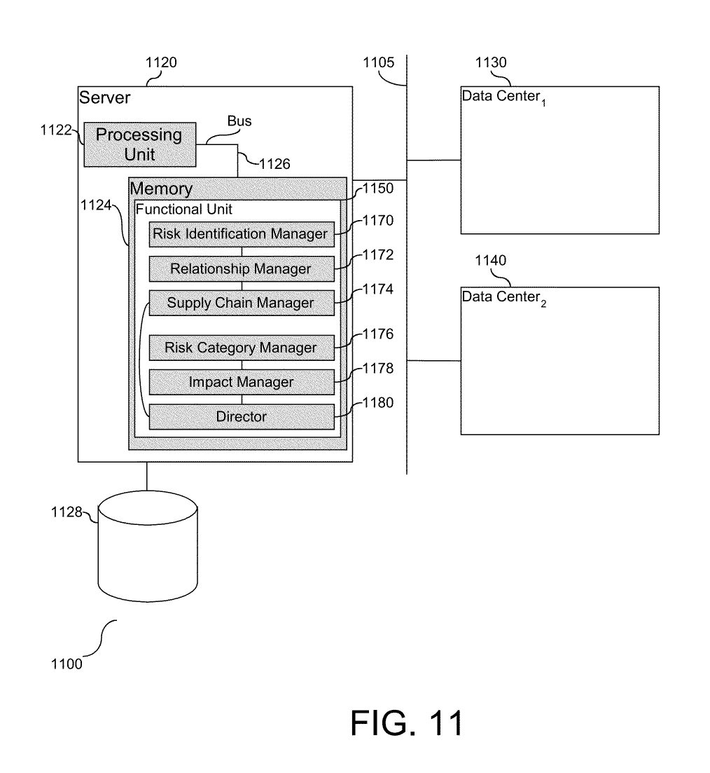

As demonstrated in FIGS. 1-10, risks in one or more supply chains are identified, assessed, and vertically and/or horizontally aggregated to identify risks present or impending within the supply chain. The identification enables mitigation of one more of the identified aspects to reduce the effect of the risks on the supply chain and product delivery. As shown in FIGS. 1-10, a method is provided to support the supply chain identification and assessment. FIG. 11 is a block diagram (1100) illustrating tools embedded in a computer system to support the technique employed for the supply chain assessment. Specifically, a server (1120) is shown with a processing unit (1122), in communication with memory (1124) across a bus (1126), and in communication with data storage (1128). In one embodiment, the server (1120) is in communication with a shared pool of configurable computer resources, each of the configurable resources having processing units in communication with data storage. The configurable resources may be represented as nodes in separate data centers in the shared pool. For illustrative purposes, the server (1120) is shown in communication with two data centers (1130) and (1140) across a network connection (1105). Accordingly, one or more data centers may be employed to support supply chain assessment with communication among the data centers supported across one or more network connections (1105).

A functional unit (1150) is provided with one or more tools to support the implementation of the supply chain risk assessment and management. The functional unit (1150) is shown local to the server (1120). However, in one embodiment, the functional unit (1150) may be local to any of the data centers supporting the supply chain risk assessment. The tools include, but are not limited to, a risk identification manager (1170), a relationship manager (1172), a supply chain manager (1174), a risk category manager (1176), an impact manager (1178), and a director (1180). The risk identification manager (1170) is provided to identify risks in a brand commodity supply-chain employed to deliver a commodity into a brand. The identified risks include a first risk for an immediate component supply-chain and a second risk for a final assembly supply-chain. The relationship manager (1172) is provided in communication with the risk identification manager (1170). More specifically, the relationship manager (1172) functions to form a visible relationship among disparate pieces of information associated with the identified risks. In one embodiment, disparate pieces of information reflect a collection of information from many places. The relationship manager (1172) organizes the disparate pieces of information in a logical manger in order to create a single holistic image for risks in the brand commodity supply chain. The supply chain manager (1174) is provided in communication with the relationship manager (1172). The supply chain manager (1174) functions to identify a relevant supply chain for a risk assessment, and to evaluate the identified risks for impact evaluation.

The supply chain manager (1174) integrates the identified risks for both an intermediate component supply-chain and a final assembly supply-chain, with an aggregation of elements in the supply chain. Finally, the director (1180) is provided in communication with the supply chain manager (1174) to manage key risks in response to the impact evaluation. The director (1180) deploys risk mitigation to a risk identified to affect supply chain sustainability. Accordingly, the managers and directors identify and assess risks in the brand commodity supply chain in order to mitigate the effect of the risks on sustenance of the supply chain.

As outlined above, there are additional managers provided in communication with the functional unit to support risk assessment and management. These managers include, but are not limited to, the risk category manager (1176) and the impact manager (1178). The risk category manager (1176) is provided in communication with the risk identification manager (1170). Each identified risk in the brand commodity supply chain is assigned a numerical measurement. The risk category manager (1176) assess a risk category of an aspect of the supply chain and assigned to each risk category a measurement in the form of a meantime to repair impact or a likelihood of impact. To further address mitigation of risk, the impact manager (1178) is provided in communication with the risk identification manager (1170). The impact manager (1178) individually assesses an impact value for each risk category of the aspect of the supply chain. This assessment includes the impact manager (1178) assigning a meantime to repair and impact value and a likelihood to impact measurement for each risk category of the aspect of the supply chain.

The risk assessment and management may take place on a granular level or a larger macro level. For example, the impact manager (1178) may calculate an individual likelihood value and impact value for each risk category of an aspect of the supply chain. The assessments provided by the impact manager (1178) on the granular level may be employed to provide horizontal and/or vertical aggregation of risk assessment. The impact manager (1178) may provide separate aggregations across a single supply chain, multiple supply chains which supply a selected commodity, and a totality of supply chains which supply an organizational entity. With respect to a single supply chain, the impact manager (1178) aggregates the likelihood of impact values for each risk category to an aggregated likelihood impact values for an aspect of the supply chain. The aspect may include a country, hub, supplier, supplier site, or commodity. With respect to aggregation across a supply chain, the impact manager (1178) aggregates the likelihood impact values from each aspect of the supply chain into an aggregated likelihood impact value for the supply chain. Similarly, with respect to multiple supply chains, the impact manager (1178) aggregates the likelihood impact values of two or more supply chains to an aggregated likelihood impact value for all of the supply chains which supply a selected commodity. Finally, with respect to an organizational entity, the impact manager (1178) aggregates the likelihood impact values of two or more supply chains to an aggregated likelihood impact value for a totality of supply chains which supply the organizational entity. Accordingly, the impact manager (1178) functions to perform the aggregation of the supply chains on a micro and a macro level to provided risk assessment on the various levels in the brand commodity supply chain.

As identified above, the risk identification manager (1170), relationship manager (1172), supply chain manager (1174), risk category manager (1176), impact manager (1178), and director (1180) are shown residing in memory (1124) of the server (1120) local to the first data center (1110). Although in one embodiment, risk identification manager (1170), relationship manager (1172), supply chain manager (1174), risk category manager (1176), impact manager (1178), and director (1180) may reside as hardware tools external to the memory (1124) of server (1120) of the first data center (1110). The identified managers and director (1170)-(1180) may be implemented as a combination of hardware and software, or may be distributed among multiple data centers in the shared pool of resources. Similarly, in one embodiment, the managers and director (1170)-(1180) may be combined into a single functional item that incorporates the functionality of the separate items. As shown herein, each of the managers and director (1170)-(1180) are shown local to one data center. However, in one embodiment they may be collectively or individually distributed across the shared pool of configurable computer resources and function as a unit to assess and manage risks in the supply chain. Accordingly, the managers and director (1170)-(1180) may be implemented as software tools, hardware tools, or a combination of software and hardware tools.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

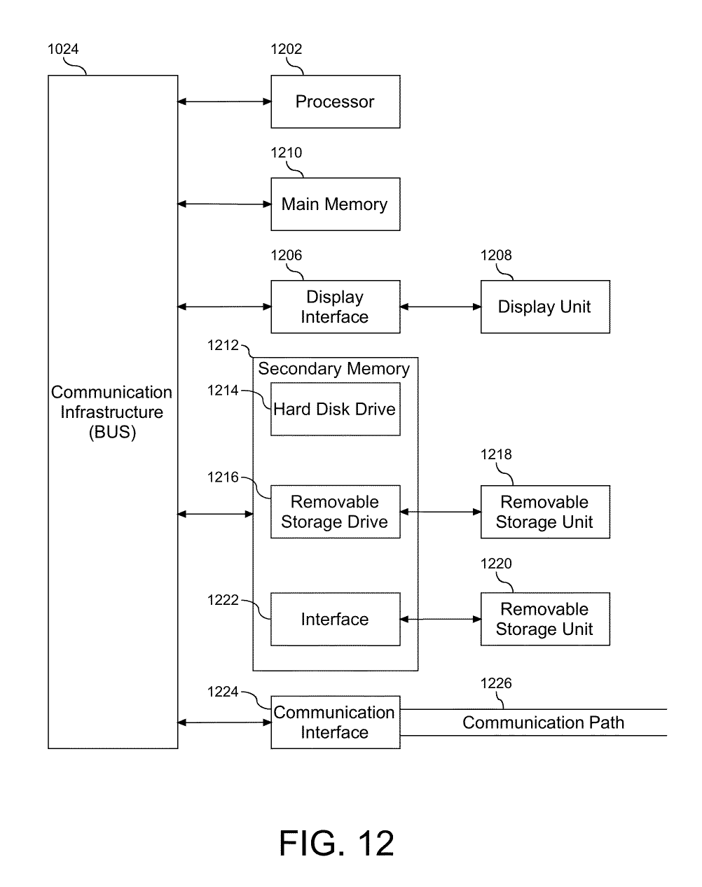

Referring now to FIG. 12 is a block diagram (1200) showing a system for implementing an embodiment of the present invention. The computer system includes one or more processors, such as a processor (1202). The processor (1202) is connected to a communication infrastructure (1204) (e.g., a communications bus, cross-over bar, or network). The computer system can include a display interface (1206) that forwards graphics, text, and other data from the communication infrastructure (1204) (or from a frame buffer not shown) for display on a display unit (1208). The computer system also includes a main memory (1210), preferably random access memory (RAM), and may also include a secondary memory (1212). The secondary memory (1212) may include, for example, a hard disk drive (1214) and/or a removable storage drive (1216), representing, for example, a floppy disk drive, a magnetic tape drive, or an optical disk drive. The removable storage drive (1216) reads from and/or writes to a removable storage unit (1218) in a manner well known to those having ordinary skill in the art. Removable storage unit (1218) represents, for example, a floppy disk, a compact disc, a magnetic tape, or an optical disk, etc., which is read by and written to by removable storage drive (1216). As will be appreciated, the removable storage unit (1218) includes a computer readable medium having stored therein computer software and/or data.

In alternative embodiments, the secondary memory (1212) may include other similar means for allowing computer programs or other instructions to be loaded into the computer system. Such means may include, for example, a removable storage unit (1220) and an interface (1222). Examples of such means may include a program package and package interface (such as that found in video game devices), a removable memory chip (such as an EPROM, or PROM) and associated socket, and other removable storage units (1220) and interfaces (1222) which allow software and data to be transferred from the removable storage unit (1220) to the computer system.

The computer system may also include a communications interface (1224). Communications interface (1224) allows software and data to be transferred between the computer system and external devices. Examples of communications interface (1224) may include a modem, a network interface (such as an Ethernet card), a communications port, or a PCMCIA slot and card, etc. Software and data transferred via communications interface (1224) are in the form of signals which may be, for example, electronic, electromagnetic, optical, or other signals capable of being received by communications interface (1224). These signals are provided to communications interface (1224) via a communications path (i.e., channel) (1226). This communications path (1226) carries signals and may be implemented using wire or cable, fiber optics, a phone line, a cellular phone link, a radio frequency (RF) link, and/or other communication channels.

In this document, the terms “computer program medium,” “computer usable medium,” and “computer readable medium” are used to generally refer to media such as main memory (1210) and secondary memory (1212), removable storage drive (1216), and a hard disk installed in hard disk drive (1214).

Computer programs (also called computer control logic) are stored in main memory (1210) and/or secondary memory (1212). Computer programs may also be received via a communication interface (1224). Such computer programs, when run, enable the computer system to perform the features of the present invention as discussed herein. In particular, the computer programs, when run, enable the processor (1202) to perform the features of the computer system. Accordingly, such computer programs represent controllers of the computer system.

The flowcharts and block diagrams in the Figures illustrate the architecture, functionality, and operation of possible implementations of systems, methods and computer program products according to various embodiments of the present invention. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated. Accordingly, the enhanced cloud computing model supports flexibility with respect to application processing and disaster recovery, including, but not limited to, supporting separation of the location of the data from the application location and selection of an appropriate recovery site.

### Alternative Embodiment

It will be appreciated that, although specific embodiments of the invention have been described herein for purposes of illustration, various modifications may be made without departing from the spirit and scope of the invention. Accordingly, the scope of protection of this invention is limited only by the following claims and their equivalents.

1. A method comprising:
identifying risks in a brand commodity supply-chain for delivering a commodity into a brand, the risk identification including risks for both an intermediate component supply-chain and a final assembly supply-chain;
a processor forming a visible relationship among disparate pieces of information associated with the identified risks-by logically organizing the disparate pieces of information and creating a single holistic image for visualizing risks in the brand commodity supply chain;
the processor identifying a relevant supply chain for a risk assessment and evaluating the identified risks for impact evaluation, including the processor integrating the identified risks for both the intermediate component supply-chain and the final assembly supply-chain, with an aggregation of elements in the supply chains; and
managing key risks in response to the impact evaluation, including deployment of risk mitigation to a risk identified to affect supply chain sustainability.

2. The method of claim 1, further comprising assessing a risk category of an aspect of the supply chain, and assigning to each assessed risk category a measurement selected from the group consisting of: meantime to repair-impact and likelihood-impact.

3. The method of claim 2, further comprising individually assessing an impact value for each risk category of the aspect of the supply chain, including assigning a mean time to repair and impact value and a likelihood-impact, to the measurement.

4. The method of claim 3, further comprising individually calculating a likelihood value and an impact value for each risk category of an aspect of the supply-chain.

5. The method of claim 4, further comprising aggregating the likelihood-impact values for each risk category to aggregated likelihood impact value for one or more aspects of the supply chain.

6. The method of claim 5, further comprising aggregating the likelihood-impact values from each aspect of a supply chain into an aggregated likelihood-impact value for the supply chain.

7. The method of claim 6, further comprising aggregating the likelihood-impact values of two or more supply chains to an aggregated likelihood-impact value for a totality of supply chains which supply a selected commodity.

8. The method of claim 6, further comprising aggregating the likelihood-impact values of two or more supply chains to an aggregated likelihood-impact value for a totality of supply chains which supply an organizational entity.

9. A system comprising:
a processor in communication with memory;
a functional unit in communication with the memory, the functional unit comprising tools to support risk assessment, the tools comprising:
a risk identification manager to identify risks in a brand commodity supply-chain employed to deliver a commodity into a brand, the identified risks include a first risk for an immediate component supply-chain and a second risk for a final assembly supply-chain;
a relationship manager in communication with the risk identification manager, the relationship manager to form a visible relationship among disparate pieces of information associated with the identified risks, the relationship manager to logically organize the disparate pieces of information and to create a single holistic image for risks in the brand commodity supply chain;
a supply chain manager in communication with the relationship manager, the supply chain manager to identify a relevant supply chain for a risk assessment and to evaluate the identified risks for impact evaluation, the supply chain manager to integrate the identified risks for both the intermediate component supply-chain and the final assembly supply-chain, with an aggregation of elements in the supply chain; and
a director in communication with the supply chain manager, the director to manage key risks in response to the impact evaluation, the director to deploy risk mitigation to a risk identified to affect supply chain sustainability.

10. The system of claim 9, further comprising a risk category manager in communication with the risk identification manager, the risk category manager to assess a risk category of an aspect of the supply chain and to assign to each assessed risk category a measurement selected from the group consisting of: meantime to repair-impact and likelihood-impact.

11. The system of claim 10, further comprising an impact manager in communication with the risk identification manager, the impact manager to individually assess an impact value for each risk category of the aspect of the supply chain, including the impact manager to assign a meantime to repair and impact value and a likelihood-impact value to the measurement.

12. The system of claim 11, further comprising the impact manager to individually calculate a likelihood value and an impact value for each risk category of an aspect of the supply chain.

13. The system of claim 12, further comprising the impact manager to aggregate the likelihood-impact values for each risk category to an aggregated likelihood impact value for an aspect of the supply chain, the aspect selected from the group consisting of: country, hub, supplier site, and commodity.

14. The system of claim 13, further comprising the impact manager to aggregate the likelihood impact values from each aspect of a supply chain into an aggregated likelihood impact value for the supply chain.

15. The system of claim 14, further comprising the impact manager to aggregate the likelihood impact values of two or more supply chains to an aggregated likelihood impact value for a totality of supply chains which supply a selected commodity.

16. The system of claim 14, further comprising the impact manager to aggregate the likelihood impact values of two or more supply chains to an aggregated likelihood impact value for a totality of supply chains which supply an organizational entity.

17. A computer program product comprising a non-transitory computer readable storage medium having computer readable program code embodied therewith, the computer readable program code when executed on a computer causes the computer to:
identify risks in a brand commodity supply-chain for delivering a commodity into a brand, the risk identification including risks for both an intermediate component supply-chain and a final assembly supply-chain;
form a visible relationship among disparate pieces of information associated with the identified risks by logically organizing the disparate pieces of information and creating a single holistic image to visualize risks in the brand commodity supply chain;
identify a relevant supply chain for a risk assessment and evaluate the identified risks for impact evaluation, including integrating the identified risks for both the intermediate component supply-chain and the final assembly supply-chain, with an aggregation of elements in the supply chains; and
manage key risks in response to the impact evaluation, including deployment of risk mitigation to a risk identified to affect supply chain sustainability.

18. The computer program product of claim 17, further comprising program code to assess a risk category of an aspect of the supply chain, and to assign to each assessed risk category a measurement selected from the group consisting of: meantime to repair-impact and likelihood-impact.

19. The computer program product of claim 18, further comprising program code to individually assess an impact value for each risk category of the aspect of the supply chain, including assigning a mean time to repair and impact value and an, a likelihood and impact, to the measurement.

20. The computer program product of claim 19, further comprising program code to individually calculate a likelihood value and an impact value for each risk category of an aspect of the supply-chain.

21. The computer program product of claim 20, further comprising program code to aggregate the likelihood-impact values for each risk category to aggregated likelihood impact value for an aspect of the supply chain.

22. The computer program product of claim 21, further comprising program code to aggregate the likelihood impact values from each aspect of a supply chain into an aggregated likelihood impact value for the supply chain.

23. The computer program product of claim 22, further comprising program code to aggregate the likelihood-impact values of two or more supply chains to an aggregated likelihood-impact value for a totality of supply chains which supply a selected commodity.

24. The computer program product code of claim 22, further comprising program code to aggregate the likelihood-impact values of two or more supply chains to an aggregated likelihood-impact value for a totality of supply chains which supply an organizational entity.
